(19) United States
(12) Patent Application Publication
(10) Pub. No.: US 2008/0084015 A1
(43) Pub. Date: Apr. 10, 2008

(54) Multi-adjustable device for holding, leveling, positioning, and securing structures with multiple attachments

(76) Inventors: Michael G. Crago, Churchill, MT (US); John J. McMorrow, Belgrade, MT (US)

Correspondence Address: Michael G. Crago, 6060 Pleasant Street, Churchill, MT, 59741, US

(21) Appl. No.: 11/516,407

(22) Filed: Sep. 6, 2006

(51) Int. Cl. B25B 1/20

(52) U.S. Cl. 269/45

(57) ABSTRACT

A system that is functional user friendly, safe and can be utilized in many applications and industries. A body that may be constructed of a rigid material such as ferrous, or non-ferrous metal, laminates, composites, and polymers depending on the industry and application. The main body of the system attaches to existing strait clamp systems and can be adjusted vertically or horizontally and locked into position. The system incorporates series of elbow's that can be utilized for holding structures in place in tight areas and adjusted to precise degrees and angles. The main body slides horizontally on an existing straight clamp system and can be locked into position with a cam lock. There is a receptacle on the body front which allows you to place the desired attachment for the application, this attachment can be adjusted vertically and locked into place with a thumb screw and or cam lock.

### RELATED APPLICATIONS

The present application is related to U.S. Pat. No. 6,932,334 B1, issued Aug. 23, 2005, for DEVICE FOR SUPPORTNG DUCTWORK DURING INSTALLATION, by Garrol C. Gregory, included by reference herein.

### FIELD OF THE INVENTION

The present invention relates to a system and, more particularly, to a main body with adjustable elbows that accommodate many attachments that can secure, level, and position a variety of structures depending on the industry, application, and also reduces the need for additional persons to complete specific tasks.

### BACKGROUND OF THE INVENTION

While doing some consultation for a friend's plumbing and heating company I observed what is considered to be a common protocol for hanging HVAC duct in a floor joist which required two workers in this case, a journeyman and an apprentice. I approached the journeyman and asked him a few questions as far as the method that he utilized for hanging duct. He explained that without an apprentice he would have to place duct strap in the joist to balance one end of the ducting and try to manipulate the other side of the duct until the ducting was connected. At this point he would have to balance the unsecured end of the ducting with his head until the duct strap was screwed into place and then would have to readjust the back duct strap to make sure the ducting was level. This is very time consuming and dangerous. This particular journeyman had several scars on his nose and forehead from the duct slipping off of his head and catching his forehead and nose requiring many stitches. This was a very common accident in the tin trade.

Over a couple of weeks I found similar problems with the electricians, framers, and plumbers. I realized that there was a need for a system that would act as a second set of hands and not only free up employees to perform more important duties, but to also provide safety for workers. The design would have to be user friendly and functional.

I spent a great deal of time trying to find a product that would address the efficiency and safety issues but couldn't find anything commercially available that would work. During exhausting patent searching finally I came across one item that was designed specifically for hanging duct. This was U.S. Pat. No. 6,932,334, “Device for supporting ductwork during installation”.

The only other existing device that I found is limited and really doesn't offer a viable solution to the problem. It is basically a trapeze that hangs from a joist and the ducting sits on the device. One of the many short comings is that the device hangs from a clamp similar to a jumper cable clamp so the duct actually hangs below the floor joist. The technician still has to lift the ducting and hold it inside the joist and level the ducting manually while trying to place the duct strapping. Again this means he will probably use his head to balance the ducting which may result in injury or require another technician to assist in the final placement of the duct. The design of existing art has a tendency to swing allowing the ducting to pop out of position before the set screws are in place. This device is limited as it will only adjust to different joist widths and cannot be adjusted to support ducting in the joist itself.

It is therefore an object of the invention to provide a system for securing and leveling a structure such as ducting in a specific location without the need for a second person to assist.

It is another object of the invention to provide a safe, user friendly alternative to current standards for hanging duct.

It is another object of the invention to provide a universal system that has many optional attachments that can be utilized in multiple industries for numerous applications.

### SUMMARY OF THE INVENTION

In accordance with the present invention, there is provided, a system utilized for holding, securing, and leveling various structures that is functional, user friendly, safe and can be utilized in many applications and industries. A main body that may be constructed of a rigid material such as ferrous, or non-ferrous metal, laminates, composites, and polymers depending on the industry and application. The main body of the system attaches to existing strait clamp systems and can be adjusted vertically or horizontally and locked into position. The system incorporates series of 360 degree adjusting elbow's that can be utilized for holding structures in place in tight areas and adjusted to precise degrees and angles. The main body slides horizontally on an existing straight clamp system and can be locked into position with a cam lock. There is a receptacle on the body front which allows you to place the desired attachment for a specific application, this attachment can be adjusted vertically and locked into place with a thumb screw and or cam lock.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a hold-it-all system with ducting attachments;

FIG. 2 is a top partial view of an inside front of the 360 degree adjustable grooved elbow with locking teeth, spring receptacle, and self centering collar;

FIG. 3 is a top partial view of a front top 360 degree adjustable grooved elbow with spring lock element and accommodating hole for rod;

FIG. 4 is a top partial view of a front, top of 360 degree adjustable grooved elbow with spring lock element;

FIG. 5 is a bottom partial view of an inside back of 360 degree adjustable grooved elbow with locking teeth, threaded insert and self centering receiving collar;

FIG. 6 is a bottom partial view of a bottom back elbow with-accommodating hole for rod and lock kdown element;

FIG. 7 is a bottom partial view of a top, back of 360 degree adjusting grooved elbow;

FIG. 8 is a top partial view of the 360 degree adjustable friction locking elbow with self centering collar, spring receptacle, and friction surface;

FIG. 9 is a top partial view of a front top of 360 degree adjustable friction locking elbow with spring locking element and accommodating rod hole;

FIG. 10 is a top partial view of the top 360 degree adjustable friction locking elbow with spring locking element;

FIG. 11 is a bottom partial view of the back inside of the 360 degree adjustable friction locking elbow with the self centering receiving collar, spring hole, threaded insert, and friction surface;

FIG. 12 is a bottom partial view of a bottom back of 360 degree adjustable friction locking elbow with lock down element and accommodating rod hole;

FIG. 13 is a bottom partial view of a top of back 360 degree adjustable friction locking elbow;

FIG. 14 is a perspective view of the short duct pipe attachment with proprietary indexing element;

FIG. 15 is a perspective view of the long duct pipe attachment with proprietary indexing element;

FIG. 16 is a perspective view of the carpenters portable support roller assembly with proprietary indexing element;

FIG. 17 is an exploded view of the hold-it all system body showing all elements of the main body;

FIG. 18 is an exploded view of a 360 degree adjustable locking grooved elbow and it's elements; and

FIG. 19 is an exploded view of a 360 degree adjustable friction locking elbow and it's elements.

For purposes of clarity and brevity, like elements and components will bear the same designations and numbering throughout the Figures.

### DESCRIPTION OF THE PREFERRED EMBODIMENT

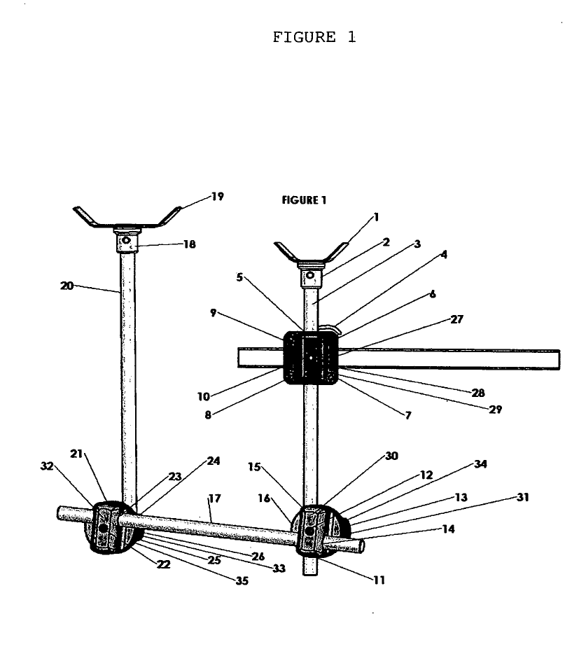

FIG. 1 is a perspective view of the hold-it-all system with ducting attachments.

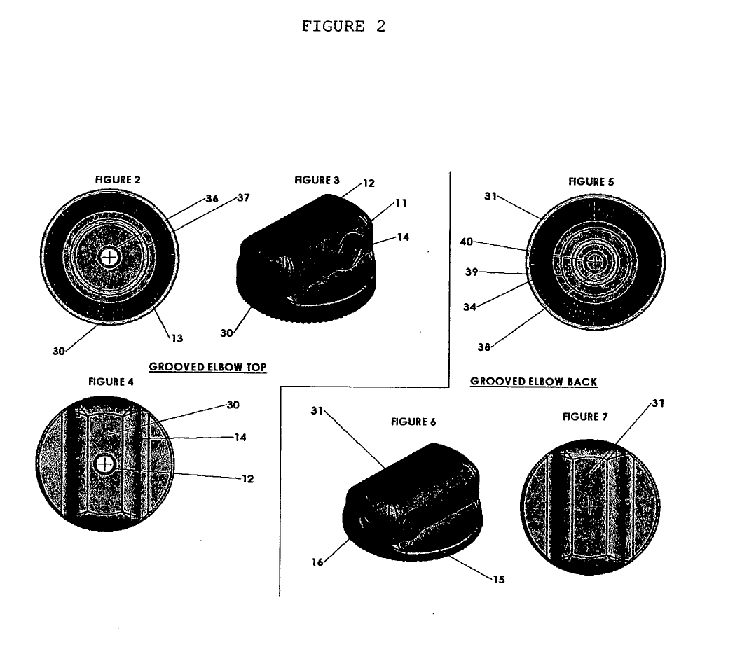

FIG. 2 is a top partial view of a detail of top, inside front of the 360 degree adjustable grooved elbow with locking teeth and self centering collar.

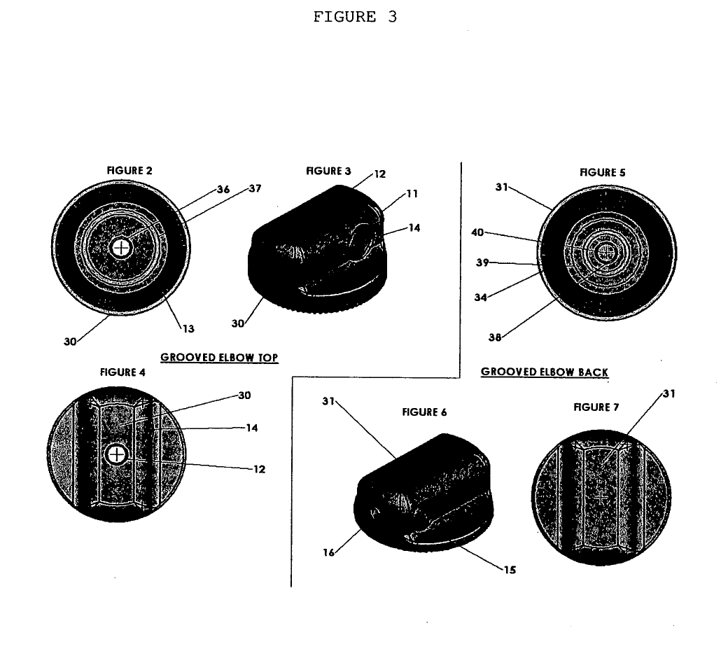

FIG. 3 is a top partial view of the detail of front top 360 degree adjustable grooved elbow with spring lock element and accommodating hole for rod.

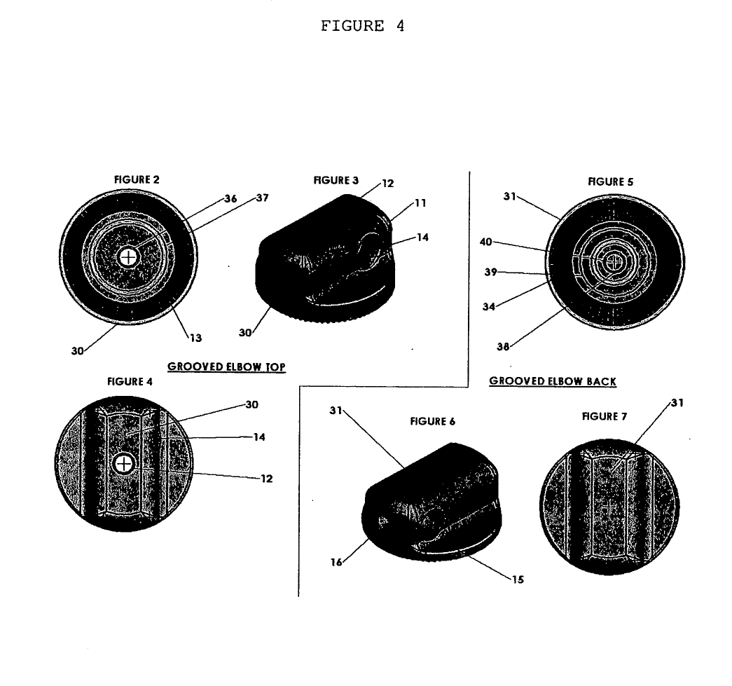

FIG. 4 is a top partial view of the front detail of top of 360 degree adjustable grooved elbow with spring lock element.

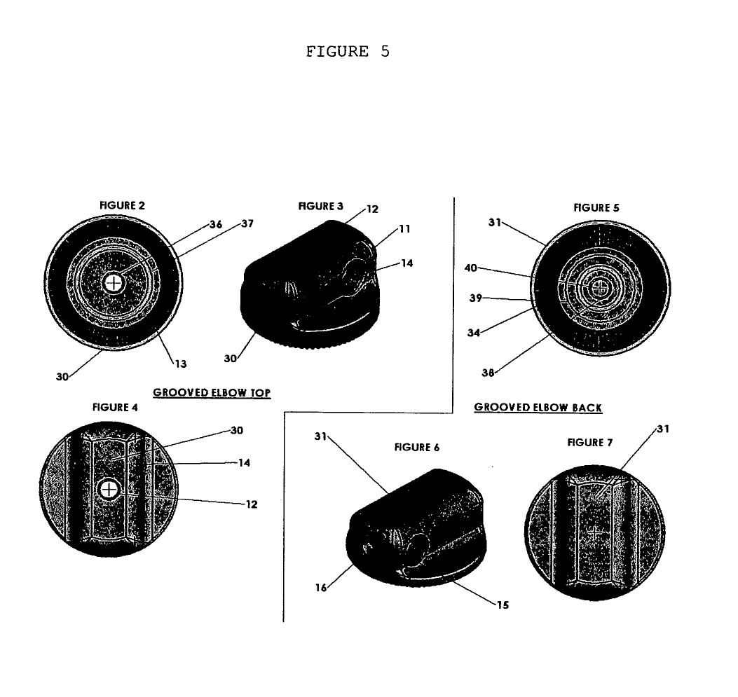

FIG. 5 is a bottom partial view of the inside back of 360 degree adjustable grooved elbow with locking teeth, threaded insert and self centering receiving collar.

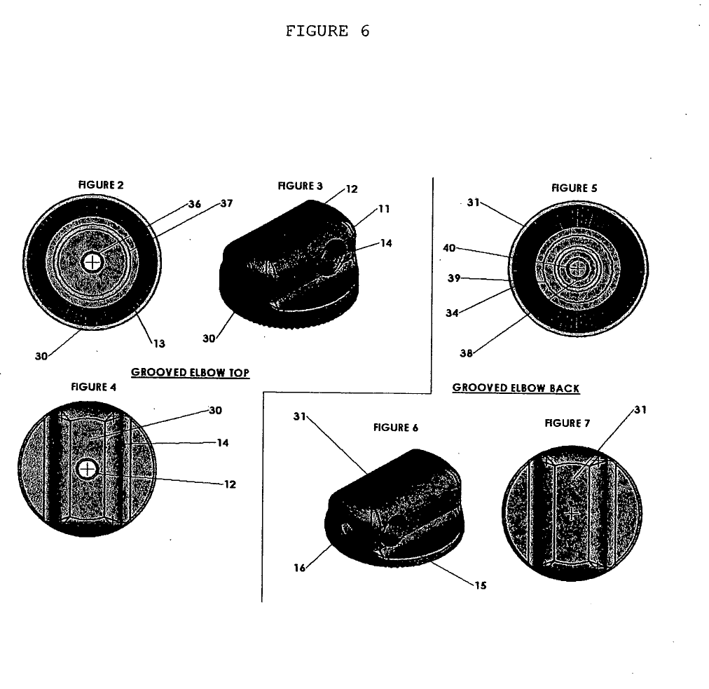

FIG. 6 is a bottom partial view of the detail of bottom back elbow with accommodating hole for rod and lock down element.

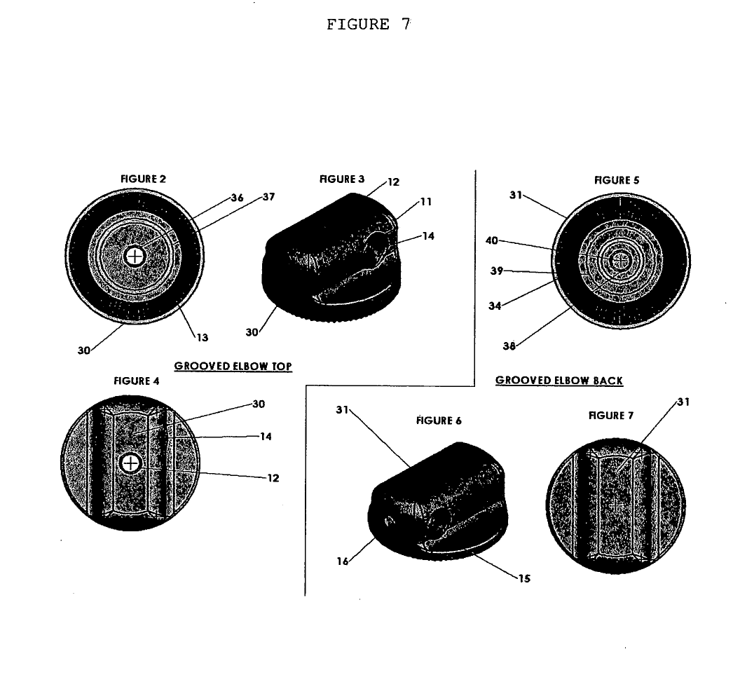

FIG. 7 is a bottom partial view of the detail of top, back of 360 degree adjusting grooved elbow.

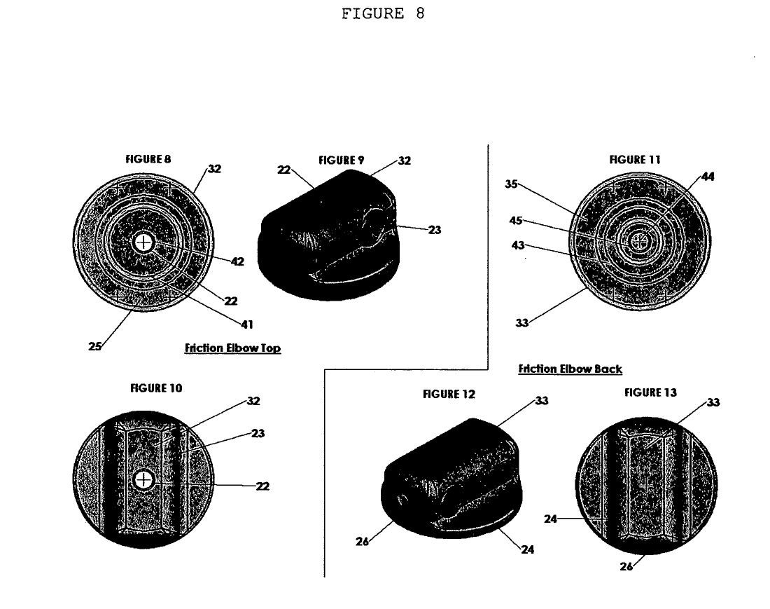

FIG. 8 which is a top partial view of the 360 degree adjustable friction locking elbow with self centering collar, spring receptacle and friction surface.

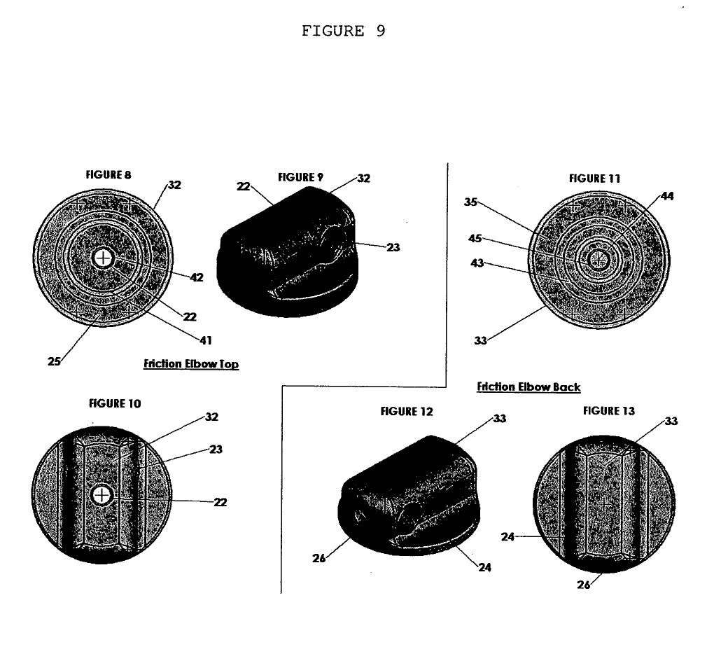

FIG. 9 which is a top partial view of the front 360 degree adjustable friction locking elbow with the spring locking element and accommodating rod hole.

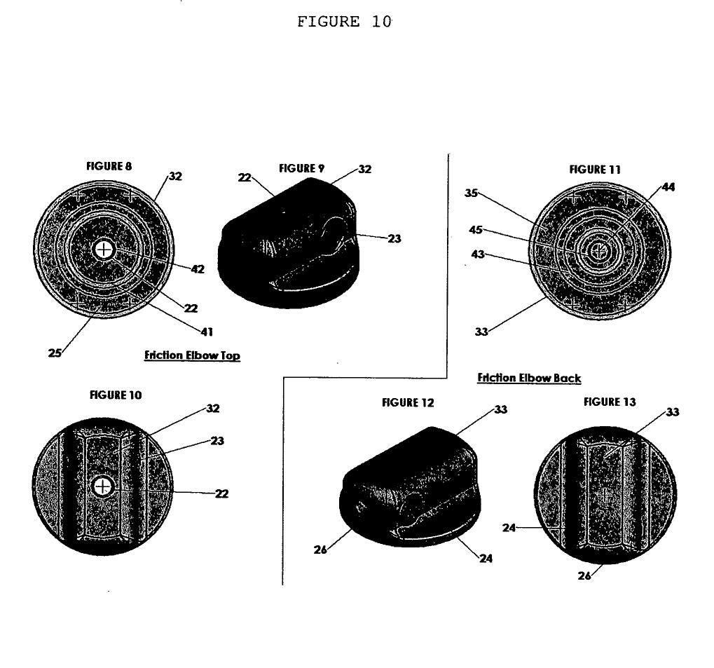

FIG. 10 which is a top partial view of the top 360 degree adjustable friction locking elbow.

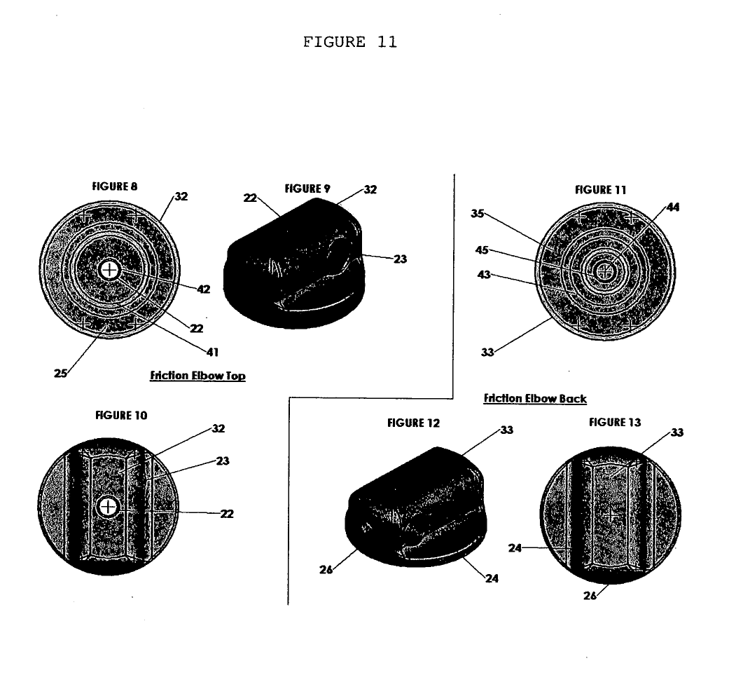

FIG. 11 which is a bottom partial view of the back inside of the 360 degree adjustable friction elbow with self centering receiving collar, spring hole, threaded insert, and friction surface.

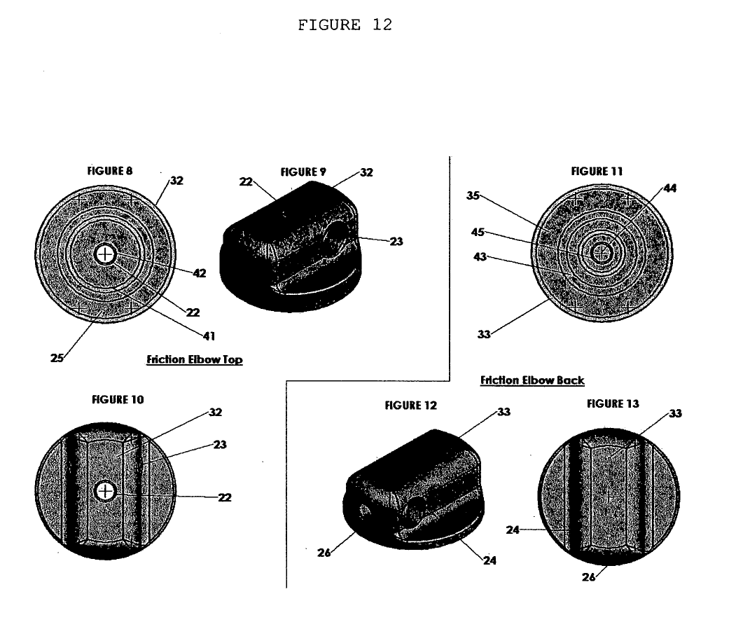

FIG. 12 which is a bottom partial view of the bottom back of the 360 degree adjustable friction locking elbow.

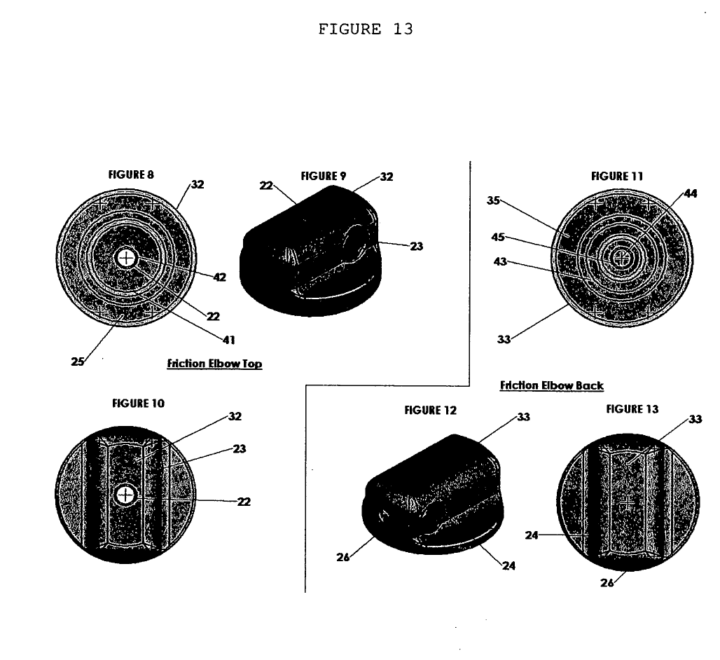

FIG. 13 which is a bottom partial view of the back 360 degree adjustable friction locking elbow.

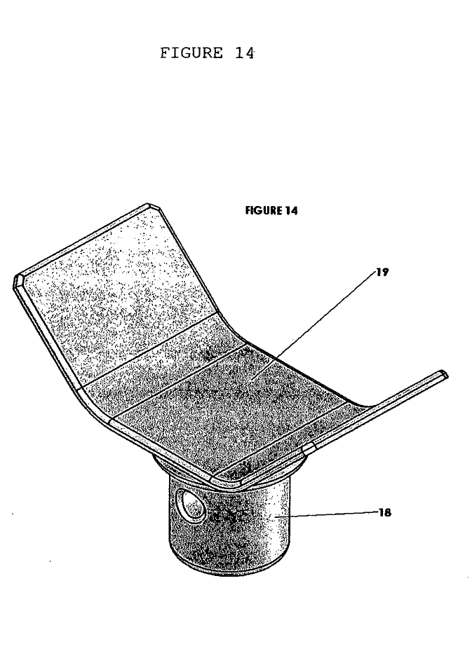

FIG. 14 which is a perspective view of the short duct pipe attachment with proprietary indexing element.

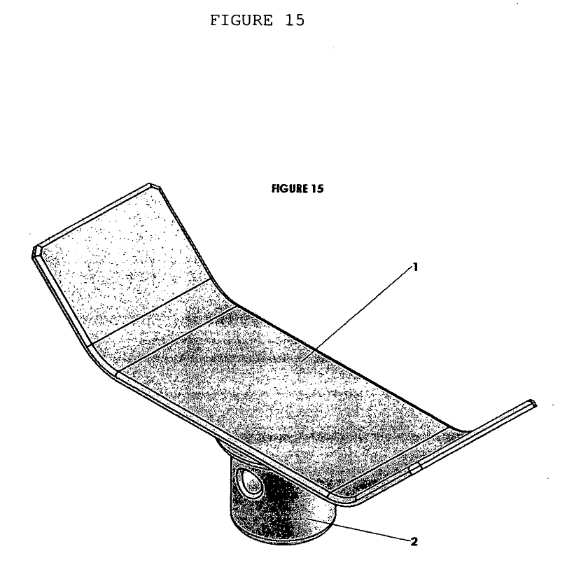

FIG. 15 which is a perspective view of the long duct pipe attachment with the proprietary indexing element.

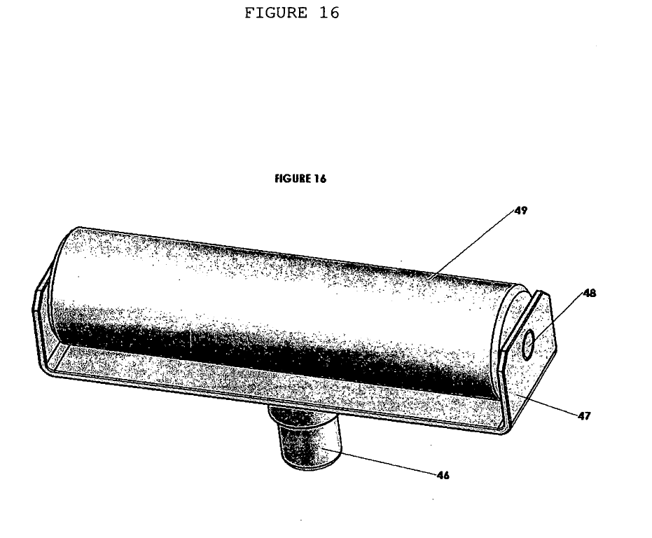

FIG. 16 which is a perspective view of the carpenters support roller with proprietary indexing element.

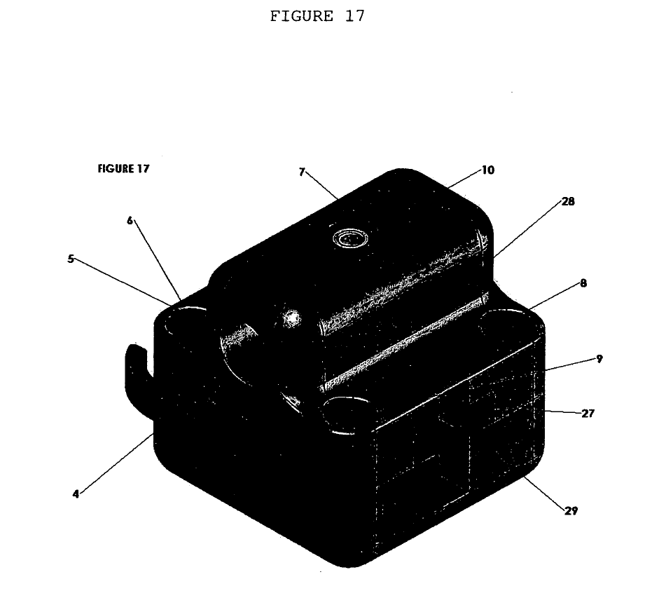

FIG. 17 which is an exploded view of the main body and it's elements.

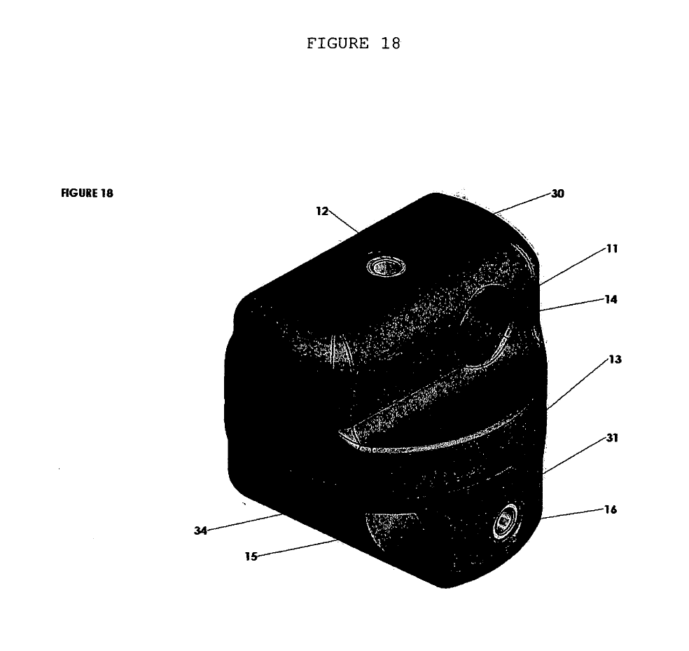

FIG. 18 which is an exploded view of the 360 degree adjustable grooved locking elbow and it's elements.

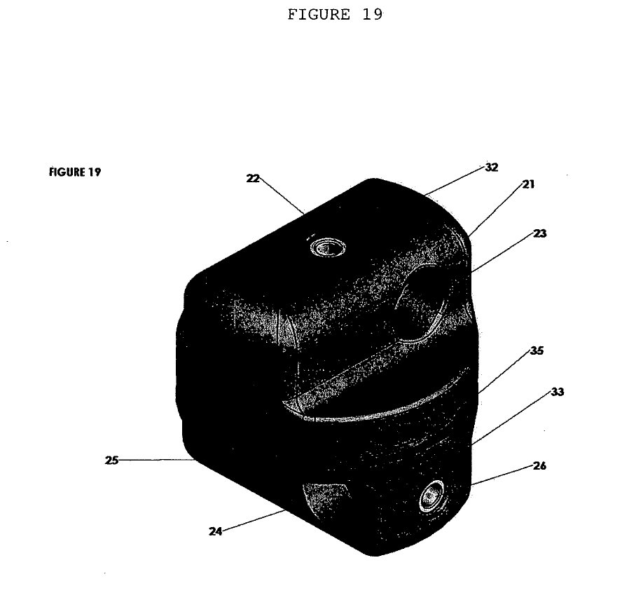

FIG. 19 which is an exploded view of the 360 degree adjustable friction locking elbow and it's elements.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A multi-adjustable device for holding, leveling, positioning, and securing structures with multiple attachments. for holding structures in a specific position or location depending on the industry and application, comprising:
means for supporting smaller ducting and pipe;
means for self locating the attachment so that it is in the proper position to perform a specific function, rigidly connected to said means for supporting smaller ducting and pipe;
means for supporting the attachments, rigidly connected to said means for self locating the attachment so that it is in the proper position to perform a specific function;
means for cam lock, locks the main body into a specific location so a structure can be secured, rigidly connected to said means for supporting the attachments;
means for holding the main body attachment rod which can be adjusted to a desired height, rigidly connected to said means for cam lock, locks the main body into a specific location so a structure can be secured;
means for securing the front to the back of main body;
means for securing the front to the back of the main body;
means for securing the front to the back of the main body;
means for securing the front to the back of the main body;
means for locking the proprietary main body attachment rod in the desired location, rigidly connected to said means for holding the main body attachment rod which can be adjusted to a desired height;
means for locking the elbow rod into the desired location, rigidly connected to said means for locking the proprietary main body attachment rod in the desired location;
means for locking the body at the desired angle and location, rigidly connected to said means for locking the elbow rod into the desired location;
means for interlocking the front of the 360 degree adjustable locking elbow to the back at a specific angle;
means for adjusting the elbow rod to desired lenghts for specific applications, rigidly connected to said means for interlocking the front of the 360 degree adjustable locking elbow to the back at a specific angle;
means for attaching the 360 adjustable locking elbow to the bottom of the main body attachment rod, and can be adjusted to desired heights, rigidly connected to said means for locking the body at the desired angle and location;
means for locking the 360 degree adjustable locking elbow to the main body attachment rod, rigidly connected to said means for attaching the 360 adjustable locking elbow to the bottom of the main body attachment rod, and can be adjusted to desired heights;
means for connecting elbows together or to affix an desired attachment to for a specific application, rigidly connected to said means for locking the 360 degree adjustable locking elbow to the main body attachment rod;
means for indexes and locates the laerge pipe attachment into the proper position, rigidly connected to said means for connecting elbows together or to affix an desired attachment to for a specific application;
means for attaching to either the mian nody attachment rod or on of the elbow rods for larger pipe hanging applications, rigidly connected to said means for indexes and locates the laerge pipe attachment into the proper position;
means for fits in the friction elbow attachment rod accomodating hole and is adjustable to desired angles and heights, rigidly connected to said means for attaching to either the mian nody attachment rod or on of the elbow rods for larger pipe hanging applications;
means for locking the front friction elbow to the elbow rod, rigidly connected to said means for fits in the friction elbow attachment rod accomodating hole and is adjustable to desired angles and heights;
means for locking the 360 degree friction locking elbow at a desired angle for a specific application, rigidly connected to said means for locking the front friction elbow to the elbow rod, and rigidly connected to said means for adjusting the elbow rod to desired lenghts for specific applications;
means for holding an elbow attachment rod with a specific attachment for a specific application and is adjustable to a desired length, rigidly connected to said means for interlocking the front of the 360 degree adjustable locking elbow to the back at a specific angle;
means for attaching the front 360 degree adjustable friction locking elbow to either the main body attachment rod or to another elbow rod to meet the needs of a specific application, rigidly connected to said means for holding an elbow attachment rod with a specific attachment for a specific application and is adjustable to a desired length;
means for 360 degree adjustable friction locking elbow inside surface face, rigidly connected to said means for attaching the front 360 degree adjustable friction locking elbow to either the main body attachment rod or to another elbow rod to meet the needs of a specific application;
means for locking the back of 360 degree adjustable friction locking elbow to either the main body attachment rod or another elbow rod, rigidly connected to said means for 360 degree adjustable friction locking elbow inside surface face;
means for attaching the hold-it-all system main body to an existing clamp;
means for locking the back to the top by the teeth interlocking for maximum grip;
means for maintaining outward force so the elbow will release when the loak down element is released, rigidly connected to said means for locking the back to the top by the teeth interlocking for maximum grip, and rigidly connected to said means for attaching the hold-it-all system main body to an existing clamp;
means for alligning the front and back sides if the grooved adjustable elbow, rigidly connected to said means for locking the back of 360 degree adjustable friction locking elbow to either the main body attachment rod or another elbow rod;
means for allowing outward preassure so elbow will seperate when lock down element is loosened, rigidly connected to said means for alligning the front and back sides if the grooved adjustable elbow;
means for adjusting and locking front and back grooved elbow at the desired angle, rigidly connected to said means for allowing outward preassure so elbow will seperate when lock down element is loosened;
means for connecting the front of the 360 degree adjustable grooved locking elbow into the back;
means for centering the top and the bottom of the friction elbow, rigidly connected to said means for connecting the front of the 360 degree adjustable grooved locking elbow into the back;
means for applying outward preassure so the top and back of the elbow will seperate when loosened, rigidly connected to said means for centering the top and the bottom of the friction elbow;
means for alligning the front and the back friction locking elbow, rigidly connected to said means for applying outward preassure so the top and back of the elbow will seperate when loosened;
means for connecting the front and the back 360 degree adjustable friction locking elbow together, rigidly connected to said means for alligning the front and the back friction locking elbow;
means for receiving the spring that applies outward preassure to the inside of the front and back of the friction elbow so the elbow seperates when the lock down element is loosened, rigidly connected to said means for connecting the front and the back 360 degree adjustable friction locking elbow together;
means for alligning the roller attachment to the top of the attachment rod;
means for holding the roller that is utilized for various applications in the construction trade;
means for allowing the roller element to rotate on its axis; and
means for rolling structures over so that they can be worked on without binding.

2. The multi-adjustable device for holding, leveling, positioning, and securing structures with multiple attachments. in accordance with claim 1, wherein said means for supporting smaller ducting and pipe comprises a specific size for smaller duct and pipe small pipe attachment.

3. The multi-adjustable device for holding, leveling, positioning, and securing structures with multiple attachments. in accordance with claim 1, wherein said means for self locating the attachment so that it is in the proper position to perform a specific function comprises an indexes the attachment into the proper position proprietary indexing base.

4. The multi-adjustable device for holding, leveling, positioning, and securing structures with multiple attachments. in accordance with claim 1, wherein said means for supporting the attachments comprises a supports attachments with proprietary attachment reciever main body attachment rod.

5. The multi-adjustable device for holding, leveling, positioning, and securing structures with multiple attachments. in accordance with claim 1, wherein said means for cam lock, locks the main body into a specific location so a structure can be secured comprises a cam locking system main body cam lock.

6. The multi-adjustable device for holding, leveling, positioning, and securing structures with multiple attachments. in accordance with claim 1, wherein said means for holding the main body attachment rod which can be adjusted to a desired height comprises a holds proprietary main body attachment rod main body accomodating hole.

7. The multi-adjustable device for holding, leveling, positioning, and securing structures with multiple attachments. in accordance with claim 1, wherein said means for securing the front to the back of main body comprises a main body assembly screw 6.

8. The multi-adjustable device for holding, leveling, positioning, and securing structures with multiple attachments. in accordance with claim 1, wherein said means for securing the front to the back of the main body comprises a main body assembly screw 7.

9. The multi-adjustable device for holding, leveling, positioning, and securing structures with multiple attachments. in accordance with claim 1, wherein said means for securing the front to the back of the main body comprises a main body assembly screw 8.

10. The multi-adjustable device for holding, leveling, positioning, and securing structures with multiple attachments. in accordance with claim 1, wherein said means for securing the front to the back of the main body comprises a main body assembly screw 9.

11. The multi-adjustable device for holding, leveling, positioning, and securing structures with multiple attachments. in accordance with claim 1, wherein said means for locking the proprietary main body attachment rod in the desired location comprises a locks attachemnt rod in place main body attachment rod lock down element.

12. The multi-adjustable device for holding, leveling, positioning, and securing structures with multiple attachments. in accordance with claim 1, wherein said means for locking the elbow rod into the desired location comprises a locks elbow rod into place 360 degree adjustable locking elbow front lock down element.

13. The multi-adjustable device for holding, leveling, positioning, and securing structures with multiple attachments. in accordance with claim 1, wherein said means for locking the body at the desired angle and location comprises a locks body at desired angle 360 degree adjustable locking elbow front body lock down element.

14. The multi-adjustable device for holding, leveling, positioning, and securing structures with multiple attachments. in accordance with claim 1, wherein said means for interlocking the front of the 360 degree adjustable locking elbow to the back at a specific angle comprises a locks body securely 360 degree adjustable locking elbow top teeth.

15. The multi-adjustable device for holding, leveling, positioning, and securing structures with multiple attachments. in accordance with claim 1, wherein said means for adjusting the elbow rod to desired lenghts for specific applications comprises a holds elbow rod 360 degree adjustable locking elbow front rod accomodating hole.

16. The multi-adjustable device for holding, leveling, positioning, and securing structures with multiple attachments. in accordance with claim 1, wherein said means for attaching the 360 adjustable locking elbow to the bottom of the main body attachment rod, and can be adjusted to desired heights comprises an attaches to bottom of main body attachment rod 360 degree adjustable locking elbow back accomodating hole.

17. The multi-adjustable device for holding, leveling, positioning, and securing structures with multiple attachments. in accordance with claim 1, wherein said means for locking the 360 degree adjustable locking elbow to the main body attachment rod comprises a locks locking elbow to main body attachment rod 360 degree adjustable locking elbow back main body rod lock down element.

18. The multi-adjustable device for holding, leveling, positioning, and securing structures with multiple attachments. in accordance with claim 1, wherein said means for connecting elbows together or to affix an desired attachment to for a specific application comprises a connects elbows together elbow attachment rod.

19. The multi-adjustable device for holding, leveling, positioning, and securing structures with multiple attachments. in accordance with claim 1, wherein said means for indexes and locates the laerge pipe attachment into the proper position comprises an indexes attachment into proper position large pipe attachment proprietary indexing element.

20. The multi-adjustable device for holding, leveling, positioning, and securing structures with multiple attachments. in accordance with claim 1, wherein said means for attaching to either the mian nody attachment rod or on of the elbow rods for larger pipe hanging applications comprises an attaches to rod for larger pipe large proprietary pipe attachment.

21. The multi-adjustable device for holding, leveling, positioning, and securing structures with multiple attachments. in accordance with claim 1, wherein said means for fits in the friction elbow attachment rod accomodating hole and is adjustable to desired angles and heights comprises an attaches to friction elbow friction elbow attachment rod.

22. The multi-adjustable device for holding, leveling, positioning, and securing structures with multiple attachments. in accordance with claim 1, wherein said means for locking the front friction elbow to the elbow rod comprises a loks friction elbow to elbow rod 360 degree adjustable friction locking elboe front lock down element.

23. The multi-adjustable device for holding, leveling, positioning, and securing structures with multiple attachments. in accordance with claim 1, wherein said means for locking the 360 degree friction locking elbow at a desired angle for a specific application comprises a lacks friction elbow at desired angle 360 degree adjustable locking elbow spring loaded lock down element.

24. The multi-adjustable device for holding, leveling, positioning, and securing structures with multiple attachments. in accordance with claim 1, wherein said means for holding an elbow attachment rod with a specific attachment for a specific application and is adjustable to a desired length comprises a holds elbow attachment rod 360 degree friction locking elbow front accomodating hole.

25. The multi-adjustable device for holding, leveling, positioning, and securing structures with multiple attachments. in accordance with claim 1, wherein said means for attaching the front 360 degree adjustable friction locking elbow to either the main body attachment rod or to another elbow rod to meet the needs of a specific application comprises an attaches the friction elbow to an attachment rod 360 degree adjustable friction elbow back attachment accomodating hole.

26. The multi-adjustable device for holding, leveling, positioning, and securing structures with multiple attachments. in accordance with claim 1, wherein said means for 360 degree adjustable friction locking elbow inside surface face comprises a friction elbow inside surface 360 degree adjustable friction surface.

27. The multi-adjustable device for holding, leveling, positioning, and securing structures with multiple attachments. in accordance with claim 1, wherein said means for locking the back of 360 degree adjustable friction locking elbow to either the main body attachment rod or another elbow rod comprises a locks the back of friction elbow to rod 360 degree friction locking elbow back lock down element.

28. The multi-adjustable device for holding, leveling, positioning, and securing structures with multiple attachments. in accordance with claim 1, wherein said means for attaching the hold-it-all system main body to an existing clamp comprises a slides over and attaches to existing clamps mian body universal clamp rod slot.

29. The multi-adjustable device for holding, leveling, positioning, and securing structures with multiple attachments. in accordance with claim 1, wherein said means for locking the back to the top by the teeth interlocking for maximum grip comprises an elbow inside surface locking teeth 360 degress adjustable locking grooved elbow bottom teeth.

30. The multi-adjustable device for holding, leveling, positioning, and securing structures with multiple attachments. in accordance with claim 1, wherein said means for maintaining outward force so the elbow will release when the loak down element is released comprises a maintains spring pressure spring hole top inside grooved adjustable elbow.

31. The multi-adjustable device for holding, leveling, positioning, and securing structures with multiple attachments. in accordance with claim 1, wherein said means for alligning the front and back sides if the grooved adjustable elbow comprises a cetner the front and back grooved elbow self centering collar front inside grooved elbow.

32. The multi-adjustable device for holding, leveling, positioning, and securing structures with multiple attachments. in accordance with claim 1, wherein said means for allowing outward preassure so elbow will seperate when lock down element is loosened comprises an allows outward preassure spring hole 360 afjustable grooved loacking elbow back.

33. The multi-adjustable device for holding, leveling, positioning, and securing structures with multiple attachments. in accordance with claim 1, wherein said means for adjusting and locking front and back grooved elbow at the desired angle comprises a locks front and back elbow 360 degree adjustable grooved elbow front teeth.

34. The multi-adjustable device for holding, leveling, positioning, and securing structures with multiple attachments. in accordance with claim 1, wherein said means for connecting the front of the 360 degree adjustable grooved locking elbow into the back comprises a locking element screws into insert threaded insert 360 degree adjustable locking grooved elbow.

35. The multi-adjustable device for holding, leveling, positioning, and securing structures with multiple attachments. in accordance with claim 1, wherein said means for centering the top and the bottom of the friction elbow comprises a centers the top and bottom of elbow self centering collar for 360 degree adjustable friction locking elbow top.

36. The multi-adjustable device for holding, leveling, positioning, and securing structures with multiple attachments. in accordance with claim 1, wherein said means for applying outward preassure so the top and back of the elbow will seperate when loosened comprises an applies outward preassure spring hole for 360 degree adjustable friction locking top spring hole.

37. The multi-adjustable device for holding, leveling, positioning, and securing structures with multiple attachments. in accordance with claim 1, wherein said means for alligning the front and the back friction locking elbow comprises a self alligns front and back elbow reciever collar 360 degree adjustable friction locking elbow back.

38. The multi-adjustable device for holding, leveling, positioning, and securing structures with multiple attachments. in accordance with claim 1, wherein said means for connecting the front and the back 360 degree adjustable friction locking elbow together comprises a connects front to back of friction elbow threaded insert for 360 degree adjustable friction locking elbow inside back.

39. The multi-adjustable device for holding, leveling, positioning, and securing structures with multiple attachments. in accordance with claim 1, wherein said means for receiving the spring that applies outward preassure to the inside of the front and back of the friction elbow so the elbow seperates when the lock down element is loosened comprises a recieves spring for outward preassure spring hole for 360 degree adjustable friction locking elbow back.

40. The multi-adjustable device for holding, leveling, positioning, and securing structures with multiple attachments. in accordance with claim 1, wherein said means for alligning the roller attachment to the top of the attachment rod comprises a self alligns the attachment proprietary indexing element for roller attachment.

41. The multi-adjustable device for holding, leveling, positioning, and securing structures with multiple attachments. in accordance with claim 1, wherein said means for holding the roller that is utilized for various applications in the construction trade comprises a body that holds the roller unit roller attachment base.

42. The multi-adjustable device for holding, leveling, positioning, and securing structures with multiple attachments. in accordance with claim 1, wherein said means for allowing the roller element to rotate on its axis comprises an allow roller to roll roller attachment axel.

43. The multi-adjustable device for holding, leveling, positioning, and securing structures with multiple attachments. in accordance with claim 1, wherein said means for rolling structures over so that they can be worked on without binding comprises a spins loosley roller attachment roller element.

44. A multi-adjustable device for holding, leveling, positioning, and securing structures with multiple attachments. for holding structures in a specific position or location depending on the industry and application, comprising:
a specific size for smaller duct and pipe small pipe attachment, for supporting smaller ducting and pipe;
an indexes the attachment into the proper position proprietary indexing base, for self locating the attachment so that it is in the proper position to perform a specific function, rigidly connected to said small pipe attachment;
a supports attachments with proprietary attachment reciever main body attachment rod, for supporting the attachments, rigidly connected to said proprietary indexing base;
a cam locking system main body cam lock, for cam lock, locks the main body into a specific location so a structure can be secured, rigidly connected to said main body attachment rod;
a holds proprietary main body attachment rod main body accomodating hole, for holding the main body attachment rod which can be adjusted to a desired height, rigidly connected to said main body cam lock;
a main body assembly screw 6, for securing the front to the back of main body;
a main body assembly screw 7, for securing the front to the back of the main body;
a main body assembly screw 8, for securing the front to the back of the main body;
a main body assembly screw 9, for securing the front to the back of the main body;
a locks attachemnt rod in place main body attachment rod lock down element, for locking the proprietary main body attachment rod in the desired location, rigidly connected to said main body accomodating hole;
a locks elbow rod into place 360 degree adjustable locking elbow front lock down element, for locking the elbow rod into the desired location, rigidly connected to said main body attachment rod lock down element;
a locks body at desired angle 360 degree adjustable locking elbow front body lock down element, for locking the body at the desired angle and location, rigidly connected to said 360 degree adjustable locking elbow front lock down element;
a locks body securely 360 degree adjustable locking elbow top teeth, for interlocking the front of the 360 degree adjustable locking elbow to the back at a specific angle;
a holds elbow rod 360 degree adjustable locking elbow front rod accomodating hole, for adjusting the elbow rod to desired lenghts for specific applications, rigidly connected to said 360 degree adjustable locking elbow top teeth;
an attaches to bottom of main body attachment rod 360 degree adjustable locking elbow back accomodating hole, for attaching the 360 adjustable locking elbow to the bottom of the main body attachment rod, and can be adjusted to desired heights, rigidly connected to said 360 degree adjustable locking elbow front body lock down element;
a locks locking elbow to main body attachment rod 360 degree adjustable locking elbow back main body rod lock down element, for locking the 360 degree adjustable locking elbow to the main body attachment rod, rigidly connected to said 360 degree adjustable locking elbow back accomodating hole;
a connects elbows together elbow attachment rod, for connecting elbows together or to affix an desired attachment to for a specific application, rigidly connected to said 360 degree adjustable locking elbow back main body rod lock down element;
an indexes attachment into proper position large pipe attachment proprietary indexing element, for indexes and locates the laerge pipe attachment into the proper position, rigidly connected to said elbow attachment rod;
an attaches to rod for larger pipe large proprietary pipe attachment, for attaching to either the mian nody attachment rod or on of the elbow rods for larger pipe hanging applications, rigidly connected to said large pipe attachment proprietary indexing element;
an attaches to friction elbow friction elbow attachment rod, for fits in the friction elbow attachment rod accomodating hole and is adjustable to desired angles and heights, rigidly connected to said large proprietary pipe attachment;
a loks friction elbow to elbow rod 360 degree adjustable friction locking elboe front lock down element, for locking the front friction elbow to the elbow rod, rigidly connected to said friction elbow attachment rod;
a lacks friction elbow at desired angle 360 degree adjustable locking elbow spring loaded lock down element, for locking the 360 degree friction locking elbow at a desired angle for a specific application, rigidly connected to said 360 degree adjustable friction locking elboe front lock down element, and rigidly connected to said 360 degree adjustable locking elbow front rod accomodating hole;
a holds elbow attachment rod 360 degree friction locking elbow front accomodating hole, for holding an elbow attachment rod with a specific attachment for a specific application and is adjustable to a desired length, rigidly connected to said 360 degree adjustable locking elbow top teeth;
an attaches the friction elbow to an attachment rod 360 degree adjustable friction elbow back attachment accomodating hole, for attaching the front 360 degree adjustable friction locking elbow to either the main body attachment rod or to another elbow rod to meet the needs of a specific application, rigidly connected to said 360 degree friction locking elbow front accomodating hole;
a friction elbow inside surface 360 degree adjustable friction surface, for 360 degree adjustable friction locking elbow inside surface face, rigidly connected to said 360 degree adjustable friction elbow back attachment accomodating hole;
a locks the back of friction elbow to rod 360 degree friction locking elbow back lock down element, for locking the back of 360 degree adjustable friction locking elbow to either the main body attachment rod or another elbow rod, rigidly connected to said 360 degree adjustable friction surface;
a slides over and attaches to existing clamps mian body universal clamp rod slot, for attaching the hold-it-all system main body to an existing clamp;
an elbow inside surface locking teeth 360 degress adjustable locking grooved elbow bottom teeth, for locking the back to the top by the teeth interlocking for maximum grip;
a maintains spring pressure spring hole top inside grooved adjustable elbow, for maintaining outward force so the elbow will release when the loak down element is released, rigidly connected to said 360 degress adjustable locking grooved elbow bottom teeth, and rigidly connected to said mian body universal clamp rod slot;
a cetner the front and back grooved elbow self centering collar front inside grooved elbow, for alligning the front and back sides if the grooved adjustable elbow, rigidly connected to said 360 degree friction locking elbow back lock down element;
an allows outward preassure spring hole 360 afjustable grooved loacking elbow back, for allowing outward preassure so elbow will seperate when lock down element is loosened, rigidly connected to said self centering collar front inside grooved elbow;
a locks front and back elbow 360 degree adjustable grooved elbow front teeth, for adjusting and locking front and back grooved elbow at the desired angle, rigidly connected to said spring hole 360 afjustable grooved loacking elbow back;
a locking element screws into insert threaded insert 360 degree adjustable locking grooved elbow, for connecting the front of the 360 degree adjustable grooved locking elbow into the back;
a centers the top and bottom of elbow self centering collar for 360 degree adjustable friction locking elbow top, for centering the top and the bottom of the friction elbow, rigidly connected to said threaded insert 360 degree adjustable locking grooved elbow;
an applies outward preassure spring hole for 360 degree adjustable friction locking top spring hole, for applying outward preassure so the top and back of the elbow will seperate when loosened, rigidly connected to said self centering collar for 360 degree adjustable friction locking elbow top;
a self alligns front and back elbow reciever collar 360 degree adjustable friction locking elbow back, for alligning the front and the back friction locking elbow, rigidly connected to said spring hole for 360 degree adjustable friction locking top spring hole;
a connects front to back of friction elbow threaded insert for 360 degree adjustable friction locking elbow inside back, for connecting the front and the back 360 degree adjustable friction locking elbow together, rigidly connected to said reciever collar 360 degree adjustable friction locking elbow back;
a recieves spring for outward preassure spring hole for 360 degree adjustable friction locking elbow back, for receiving the spring that applies outward preassure to the inside of the front and back of the friction elbow so the elbow seperates when the lock down element is loosened, rigidly connected to said threaded insert for 360 degree adjustable friction locking elbow inside back;
a self alligns the attachment proprietary indexing element for roller attachment, for alligning the roller attachment to the top of the attachment rod;
a body that holds the roller unit roller attachment base, for holding the roller that is utilized for various applications in the construction trade;
an allow roller to roll roller attachment axel, for allowing the roller element to rotate on its axis; and
a spins loosley roller attachment roller element, for rolling structures over so that they can be worked on without binding.

45. A multi-adjustable device for holding, leveling, positioning, and securing structures with multiple attachments. for holding structures in a specific position or location depending on the industry and application, comprising:
a specific size for smaller duct and pipe small pipe attachment, for supporting smaller ducting and pipe;
an indexes the attachment into the proper position proprietary indexing base, for self locating the attachment so that it is in the proper position to perform a specific function, rigidly connected to said small pipe attachment;
a supports attachments with proprietary attachment reciever main body-attachment rod, for supporting the attachments, rigidly connected to said proprietary indexing base;
a cam locking system main body cam lock, for cam lock, locks the main body into a specific location so a structure can be secured, rigidly connected to said main body attachment rod;
a holds proprietary main body attachment rod main body accomodating hole, for holding the main body attachment rod which can be adjusted to a desired height, rigidly connected to said main body cam lock;
a main body assembly screw 6, for securing the front to the back of main body;
a main body assembly screw 7, for securing the front to the back of the main body;
a main body assembly screw 8, for securing the front to the back of the main body;
a main body assembly screw 9, for securing the front to the back of the main body;
a locks attachemnt rod in place main body attachment rod lock down element, for locking the proprietary main body attachment rod in the desired location, rigidly connected to said main body accomodating hole;
a locks elbow rod into place 360 degree adjustable locking elbow front lock down element, for locking the elbow rod into the desired location, rigidly connected to said main body attachment rod lock down element;
a locks body at desired angle 360 degree adjustable locking elbow front body lock down element, for locking the body at the desired angle and location, rigidly connected to said 360 degree adjustable locking elbow front lock down element;
a locks body securely 360 degree adjustable locking elbow top teeth, for interlocking the front of the 360 degree adjustable locking elbow to the back at a specific angle;
a holds elbow rod 360 degree adjustable locking elbow front rod accomodating hole, for adjusting the elbow rod to desired lenghts for specific applications, rigidly connected to said 360 degree adjustable locking elbow top teeth;
an attaches to bottom of main body attachment rod 360 degree adjustable locking elbow back accomodating hole, for attaching the 360 adjustable locking elbow to the bottom of the main body attachment rod, and can be adjusted to desired heights, rigidly connected to said 360 degree adjustable locking elbow front body lock down element;
a locks locking elbow to main body attachment rod 360 degree adjustable locking elbow back main body rod lock down element, for locking the 360 degree adjustable locking elbow to the main body attachment rod, rigidly connected to said 360 degree adjustable locking elbow back accomodating hole;
a connects elbows together elbow attachment rod, for connecting elbows together or to affix an desired attachment to for a specific application, rigidly connected to said 360 degree adjustable locking elbow back main body rod lock down element;
an indexes attachment into proper position large pipe attachment proprietary indexing element, for indexes and locates the laerge pipe attachment into the proper position, rigidly connected to said elbow attachment rod;
an attaches to rod for larger pipe large proprietary pipe attachment, for attaching to either the mian nody attachment rod or on of the elbow rods for larger pipe hanging applications, rigidly connected to said large pipe attachment proprietary indexing element;
an attaches to friction elbow friction elbow attachment rod, for fits in the friction elbow attachment rod accomodating hole and is adjustable to desired angles and heights, rigidly connected to said large proprietary pipe attachment;
a loks friction elbow to elbow rod 360 degree adjustable friction locking elboe front lock down element, for locking the front friction elbow to the elbow rod, rigidly connected to said friction elbow attachment rod;
a lacks friction elbow at desired angle 360 degree adjustable locking elbow spring loaded lock down element, for locking the 360 degree friction locking elbow at a desired angle for a specific application, rigidly connected to said 360 degree adjustable friction locking elboe front lock down element, and rigidly connected to said 360 degree adjustable locking elbow front rod accomodating hole;
a holds elbow attachment rod 360 degree friction locking elbow front accomodating hole, for holding an elbow attachment rod with a specific attachment for a specific application and is adjustable to a desired length, rigidly connected to said 360 degree adjustable locking elbow top teeth;
an attaches the friction elbow to an attachment rod 360 degree adjustable friction elbow back attachment accomodating hole, for attaching the front 360 degree adjustable friction locking elbow to either the main body attachment rod or to another elbow rod to meet the needs of a specific application, rigidly connected to said 360 degree friction locking elbow front accomodating hole;
a friction elbow inside surface 360 degree adjustable friction surface, for 360 degree adjustable friction locking elbow inside surface face, rigidly connected to said 360 degree adjustable friction elbow back attachment accomodating hole;
a locks the back of friction elbow to rod 360 degree friction locking elbow back lock down element, for locking the back of 360 degree adjustable friction locking elbow to either the main body attachment rod or another elbow rod, rigidly connected to said 360 degree adjustable friction surface;
a slides over and attaches to existing clamps mian body universal clamp rod slot, for attaching the hold-it-all system main body to an existing clamp;
an elbow inside surface locking teeth 360 degress adjustable locking grooved elbow bottom teeth, for locking the back to the top by the teeth interlocking for maximum grip;
a maintains spring pressure spring hole top inside grooved adjustable elbow, for maintaining outward force so the elbow will release when the loak down element is released, rigidly connected to said 360 degress adjustable locking grooved elbow bottom teeth, and rigidly connected to said mian body universal clamp rod slot;
a cetner the front and back grooved elbow self centering collar front inside grooved elbow, for alligning the front and back sides if the grooved adjustable elbow, rigidly connected to said 360 degree friction locking elbow back lock down element;
an allows outward preassure spring hole 360 afjustable grooved loacking elbow back, for allowing outward preassure so elbow will seperate when lock down element is loosened, rigidly connected to said self centering collar front inside grooved elbow;
a locks front and back elbow 360 degree adjustable grooved elbow front teeth, for adjusting and locking front and back grooved elbow at the desired angle, rigidly connected to said spring hole 360 afjustable grooved loacking elbow back;
a locking element screws into insert threaded insert 360 degree adjustable locking grooved elbow, for connecting the front of the 360 degree adjustable grooved locking elbow into the back;
a centers the top and bottom of elbow self centering collar for 360 degree adjustable friction locking elbow top, for centering the top and the bottom of the friction elbow, rigidly connected to said threaded insert 360 degree adjustable locking grooved elbow;
an applies outward preassure spring hole for 360 degree adjustable friction locking top spring hole, for applying outward preassure so the top and back of the elbow will seperate when loosened, rigidly connected to said self centering collar for 360 degree adjustable friction locking elbow top;
a self alligns front and back elbow reciever collar 360 degree adjustable friction locking elbow back, for alligning the front and the back friction locking elbow, rigidly connected to said spring hole for 360 degree adjustable friction locking top spring hole;
a connects front to back of friction elbow threaded insert for 360 degree adjustable friction locking elbow inside back, for connecting the front and the back 360 degree adjustable friction locking elbow together, rigidly connected to said reciever collar 360 degree adjustable friction locking elbow back;
a recieves spring for outward preassure spring hole for 360 degree adjustable friction locking elbow back, for receiving the spring that applies outward preassure to the inside of the front and back of the friction elbow so the elbow seperates when the lock down element is loosened, rigidly connected to said threaded insert for 360 degree adjustable friction locking elbow inside back;
a self alligns the attachment proprietary indexing element for roller attachment, for alligning the roller attachment to the top of the attachment rod;
a body that holds the roller unit roller attachment base, for holding the roller that is utilized for various applications in the construction trade;
an allow roller to roll roller attachment axel, for allowing the roller element to rotate on its axis; and
a spins loosley roller attachment roller element, for rolling structures over so that they can be worked on without binding.
